(19) United States
(12) Patent Application Publication
(10) Pub. No.: US 2007/0118534 A1
(43) Pub. Date: May 24, 2007

(54) AUDITING DATABASE END USER ACTIVITY IN ONE TO MULTI-TIER WEB APPLICATION AND LOCAL ENVIRONMENTS

(75) Inventors: Scott Hayes, Austin, TX (US); Debora Rinkevich, Austin, TX (US); Bryan Lowrey, Cedar Park, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Database-Brothers, Inc., Austin, TX (US)

(21) Appl. No.: 11/556,849

(22) Filed: Nov. 6, 2006

Related U.S. Application Data
(60) Provisional application No. 60/738,272, filed on Nov. 18, 2005.

(51) Int. Cl. G06F 17/30

(52) U.S. Cl. 707/10

(57) ABSTRACT

Provided are systems and methods of auditing database end user activity. The methods include extending a web application in order to tie a user of the web application to the user's web application login operation where the web application is coupled to a web application server that employs a connection pool for accessing a database. Extending the web application is carried out without modifying the web applications code. Existing application programming interfaces may be leveraged in carrying out the audit of database end user activity. All user database activity is monitored and associated with an individual user's login operation and an audit trail of the user's activity within the database is created.

### CROSS-REFERENCE TO RELATED APPLICATIONS

This non-provisional application claims priority based upon prior U.S. Provisional Patent Application Ser. No. 60/738,272 filed Nov. 18, 2005 in the name of Scott Hayes, Debora Rinkevich, and Bryan Lowrey, entitled “Auditing Database End User Activity In One To Multi-Tier Web Applications And Local Environments,” the disclosure of which is incorporated herein by reference.

### BACKGROUND OF THE INVENTION

This invention relates generally to database management, and more particularly to systems and methods for auditing database end user activity.

Sarbanes-Oxley, HIPAA, GLBA, and other legislation has caused organizations across America to become painfully aware of, and acutely attentive to, the need to track and administrate accountability for actions. Specifically, organizations have a mandate, with the threat of jail and fines, to monitor and track changes and access to their data. Organizations have had limited ability to track database users in order to tie individual users to their activities within a database. One cause of the problem has been that application servers obfuscate user authentication information (identity) at the database level due to connection pooling. Nonetheless, connection pooling is widely employed by organizations because of the performance gains related to sharing database connections, regardless of database vendor (for example, Oracle, IBM DB2, Microsoft SQL Server, and the like).

Audit capabilities provided within commonly used databases, such as IBM DB2 and Oracle, have been inadequate, providing insufficient detail related to tracking of database user activity and involving high overhead. Even if user authentication is not obfuscated by an application server, tracking changes to database data affected by a user is difficult, and tracking data retrieval/access activity for a user is even more difficult. Further, processing and storage costs associated with authenticating and tracking users, and capturing data change information, is expensive as implemented by database vendors.

Thus, a need persists for better ways to audit database end user activity.

### BRIEF SUMMARY OF THE INVENTION

Provided are methods of auditing database end user activity carried out by extending a web application in order to tie a user of the web application to the user's web application login operation where the web application is coupled to a web application server that employs a comection pool for accessing a database. In various embodiments, extending a web application is carried out without modifying the web application's code. Additionally, the methods may be carried out by leveraging an existing application programming interface associated with the database. If an existing application programming interface is not available, then a custom method is used. The methods further include monitoring user activity within the database and associating user activity with an individual user's web application login operation. An audit trail of the user's activity within the database may be created. The audit trail data can stored in a repository from which notices and reports may be created and executed.

### BRIEF DESCRIPTION OF THE DRAWINGS

For a detailed description of the various embodiments of the invention, reference will now be made to the accompanying drawing(s) in which:

FIG. 1 is a block diagram of a system in accordance with embodiments of the present invention.

### DETAILED DESCRIPTION

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first component couples to a second component, that connection may be through a direct connection, or through an indirect connection via other devices and connections. It is further noted that all functions described herein may be performed in either hardware or software, or a combination thereof, unless indicated otherwise. Additionally, the terms “a”, “an” and “the” mean “one or more” unless expressly specified otherwise.

In various embodiments, methods are provided for extending a web application in order to tie a user of the web application to the user's web application login operation where the web application is coupled to a web application server that employs a connection pool for accessing a database. The methods may be carried out without modifying the web application's code. Additionally, the methods comprise monitoring all user activity within the database and associating the user's activity within the database with the user's application login operation. One or more existing application programming interfaces (API) associated with the database may or may not be leveraged to carry out the methods. Further, the methods may include creating an audit trail of the user's activity within the database. Additional aspects of the methods may include transferring information related to a user's activity within the database to a repository, analyzing the information and running reports on the information, and generating notices related to user activity based on information in the reports. Each of the features in the embodiments can be automated.

Embodiments of the present invention may be implemented with various databases. Non-limiting examples of suitable commercially available databases include DB2, Oracle, Microsoft SQL Server, Sybase, TeraData, PostgreSQL, MySQL, Interbase, Firebird and Informix.

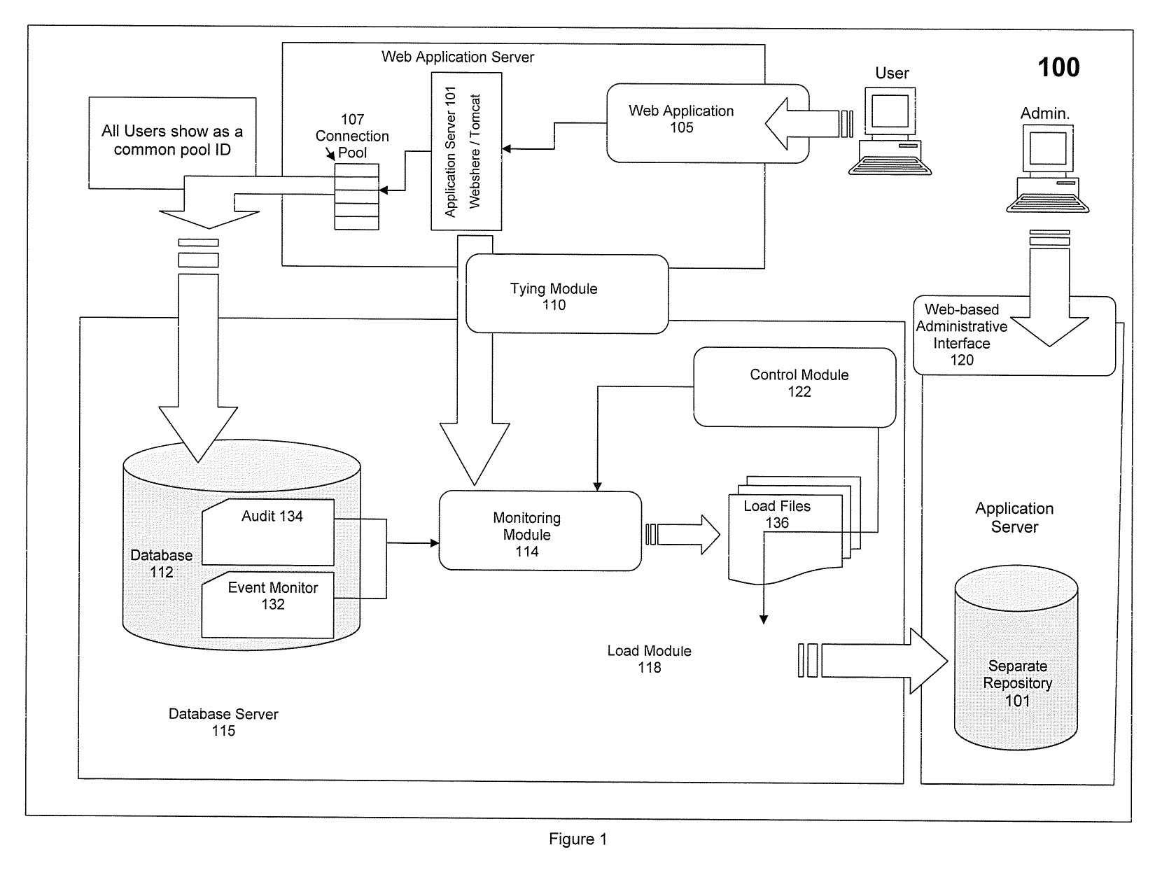

The system 100 of FIG. 1 exemplifies an embodiment of auditing database end-user activity in accordance with the present invention. Such a configuration may be compatible with databases such as IBM DB2. The same functions may be carried out with alternative system configurations, such as with Oracle or other databases listed above. Applications running within the web application server 101 may utilize a connection pool 107 for accessing a database 112. User requests that take action against the database 112 using a web application 105 request a connection from the connection pool 107. All of the connections in the pool 107 typically use the same login identifier (“login ID”) to access the database 112. To the database, it appears that all actions are initiated by the single login ID used to create the connection. Thus, the database is ordinarily unaware of web application end user identities.

The identity of the individual user taking action against the database is masked until the tying module 110 extends the existing web application's 105 binaries and captures the user identifier (“user ID”) the individual user employs to log in to the web application server 105. The operation of the tying module 110 captures, or intercepts, the identification of individuals using the connection provided by the connection pool and tracks the individual's connection.

The tying module 110 is coupled to the web application server 105 and may be integrated as an extension to the web application server 105. Each time a connection is retrieved from the connection pool 107, a fingerprint is executed against the database. In various embodiments, this could be a SQL, select statement that is executed against the database. The fingerprint, or SQL, select statement contains information such as the individual user's user ID, authentication method, IP address (login attributes), and application name. By detecting a user's user ID, login attributes, and monitoring database connections, the tying module 110 collects the information necessary to unmask which user performs which actions against the database.

On the database server 115, a monitoring module 114 monitors statement execution against the database and ties executed statements to the fingerprint (login attributes) of an individual user's connection to the database provided by the tying module. The fingerprint is combined with the application handle in the database audit and event logs to create a log file that shows the true identity of the end user requesting an action.

In some embodiments, an API provided by the database can be called by the tying module 110 to set fingerprint information (correlate a select statement with other statements executed against the database by a user), or an alternative stored procedure provided by the database, can be called to perform the same function.

Combined with the user information from the tying module 110, the monitoring module 114 creates an audit trail specifying which end user has executed each statement. Non-limiting examples of user information and activities collected into an audit trail include IP addresses, number of rows retrieved, logging in to the database, logging out of the database, executing statements, executing database procedures or functions, executing database utilities, executing database commands, executing security changes. A load module 118 periodically moves audit trail data, including all database SQL and command statements, coupled to the relevant user connection fingerprints, to a separate repository 101.

A web based administrative interface 120 can be used to configure the processes running on the database machine. The administrative interface 120 also provides report definition capability and maintenance of the repository 101 by authorized users.

Following are specific examples of embodiments of the present invention. The terms and descriptions provided in the following examples, also illustrated by reference to FIG. 1, are given to show particular embodiments of the systems and methods disclosed, and to demonstrate a number of the practices and advantages thereof. The examples are given as a more detailed demonstration of some of the embodiments disclosed, and are not intended to limit this description or the claims to follow in any manner.

Information provided from the tying module 110 is used to correlate a connection-pool 107 masked user to an individual web application 105 user. This information is communicated via a SELECT SQL statement with a literal select list. This statement is inserted into the user's current transaction and is detected by the statement event monitor 132.

The tying module 110 makes use of a programming technique called “Aspect-Oriented programming” (“AOP”). The tying module 110 is a set of aspects listening for events that occur within a given application's servlet container. The aspects make use of load-time weaving, so no knowledge of existing code is necessary. Advice contained within the aspects can be weaved into the existing application code binaries using definition files. The Advice is responsible for detecting user login information and database access requests.

Aspects check for various calls within the system and execute code at appropriate join points. AOP.xml specifies which classes/packages should be weaved with which aspects. The file is placed in the classpath in order to be loaded by the weaver at web archive file deployment.

A pointcut is defined to check for all “do*(doPost, doGet, doUpdate etc.)” requests coming in to the servlet. From the servlet request header, the origin IP address of the browser can be determined.

Some web applications may use Java Authentication and Authorization Service (“JAAS”). JAAS allows the use of one or more login modules during user authentication. Each login module may be configured so that any number of login calls may succeed or fail. A failure does not necessarily mean that the overall login fails.

If a set of logins is determined to be successful, the commit( ) routine of each login module can be called. During the commit routine, the Login Module should add principal information to the accumulated subject of the login.

Upon return from commit, the advice retrieves subject information and uses it in a SQL SELECT fingerprint statement. Additionally, the advice attempts to determine the type of authentication executed. Any methods authenticated by a module of unknown origin go into an ‘other’ column.

For applications that do not use JAAS, the aspect can check for likely login methods such as “login(string, string)”. If a method with this signature successfully returns, the username can be assumed to be the first parameter. Further, based on the return signature of the method, examples of a successful return is considered to be: a Boolean value of ‘true’; an integer value of ‘1’; a completed method not throwing an exception.

The aspect can use the connection handle returned from a Java Database Connectivity (JDBC) API ‘getConnection’ to issue a fingerprint. This connection represents the same connection that is used by the calling application. Further, a SELECT statement containing fingerprint information (i.e. end user identity attributes) can be executed against the database to mark the beginning of the current user's transactions. All SQL operations on this connection are assigned to the current user until another SELECT fingerprint string is seen on this connection. In other implementations, a fingerprint table tracking users to connections may be employed.

The SELECT statement may be of the form SELECT <values> FROM SYSIBM.SYSDUMMY1 where values represent the captured fingerprint information. The SYSDUMMY1 table is shipped with DB2 that contains 1 row with 1 column value. The fingerprint values include information such as username, logon method, and IP address. Alternatively, fingerprints can be issued in lieu of SYSIBM.DUMMY1 by accessing alternative table names that provide better performance, lower overhead, and/or are better suited to target the capabilities of the particular database. A sample select statement would look like “Select ‘DBI FINGERPRINT’, ‘Thread:http-8080-Processor25’, RemoteAddress:127.0.0.1‘,’class com.dbi.bwd.test.DBIPrincipal:bob’, Thread:Thread-36‘,’class com.dbi.bwd.test.DBIPrincipal:threadedUser’, ‘ts:2006-06-20 18:30:26.687’ from sysibm.sysdummy1”.The tying monitor 110 is not constrained to using only a SELECT SQL statement, as other methods/embodiments may deploy other statement types that the database is capable of processing (e.g. SQL UPDATE or XQuery). This fingerprint statement is then detected as part of the web user's transaction by the monitoring module 114 sitting on the database server 115.

The control module 122 stops and starts all other system components on the monitored host. The control module 122 also serves as the point of entry for configuration of the database server processes. The control module 122 can be started on server boot up, and stays resident as a daemon process.

The control module 122 checks a TCP port. Commands are sent from an administrative interface 120 to start auditing a database, stop auditing a database, configure auditing, and to check the status of auditing. Each message can be communicated in a predefined XML format.

The monitoring module 114 is responsible for collecting audit data from the event monitors and the audit facility and then creating load files 136 for the load module 118. There may be one monitoring module 114 per instance (e.g. DB2 LUW Instance). Internally, a thread is created for each partition of the database 112 that is audited. There are two main sources of audit data: the Event Monitor 132 stream; and the Audit 134 facility, accessed via the db2audit command line. As each of these sources generates data, an audit record is written to the load files 136. Other databases may have different data sources. A sample DB2 event monitor record in plain text format may look similar to

3) Connection Header Event . . .

Appl Handle: 1130
Appl Id: *LOCAL.DB2.060725211519
Appl Seq number: 0006
DRDA AS Correlation Token:

*LOCAL.DB2.060725211519

| Program Name | : db2bp.exe |
|---|---|
| Authorization Id: DB2UserName | |
| Execution Id | : DB2UserName |

Codepage Id: 1252
Territory code: 1
Client Process Id: 4988
Client Database Alias: SAMPLE
Client Product Id: SQL08022
Client Platform: Unknown
Client Communication Protocol: Local
Client Network Name: ClientMachine
Connect timestamp: 07/25/2006 16:15:24.646204

The monitoring module looks at the Appl Handle in the connection event header to tie activity back to the fingerprint identity. As the fingerprint identity issue by the typing module 110 is inserted at the beginning of the user transaction, all subsequent activity using the same connection, defined by the Appl Handle, can be assumed to be by the same user identified in the fingerprint statement until another such fingerprint statement is found on that connection or the connection disconnects.

An event monitor 132 for connections and statements is created for each database partition collected. Connection header events are used to build up a list of current database connections. Each current connection is tracked until a non-flushed matching connection event is seen on the event stream, thus signifying a disconnect. For each current connection, fingerprint data from SYSIBM.SYSDUMMY1 select statements generated by the tying monitor 110 is stored. The associated web user information is associated with all statements executed after the fingerprint statement. The fingerprint information is tied to additional connection activity based on the database provided application handle. When a Statement Close event is detected for a given application handle, an audit record is written out to the load files.

To offer a complete picture of auditing database activity, the DB2 audit facility is offered as an additional source of database activity. The DB2 Audit Facility is driven through the db2audit command line interface. Configuration of the db2audit scope is issued. db2audit 134 is started, and the db2audit trace logs are read in, and periodically, pruned.

The load files 136 are separated into subdirectories named after the audited database. Underlying restrictions of the db2 load command are responsible for this design. Only one db2 load operation can occur per table at one time. Alternative implementations may perform multiple loads depending on database capabilities.

A cryptographic hash function, such as md5, may be used to generate a checksum of the contents of each record of audit data. The md5 sum is then encrypted using public key cryptography by the monitoring module 114. The result, commonly known in the cryptographic field as a digital signature, is then added as a column to the audit record before the record is written to disk. This digital signature ensures that any future modifications to the audited data can be detected.

The load module 118 reads the load files 136 generated by the monitoring module 114 and executes a load process into the repository 101. Periodically, each directory is checked to see if there are load files of sufficient size or if the maximum time between loads has occurred. When such conditions are met, a db2 load command is executed. Each directory is loaded to a table on the repository 101.

Non-limiting examples of user activities that may be audited include the following: salary for employee number ‘000200’ during the month of April 2005; modification (Insert, Update, or Delete) of the employee table between 2005-03-08-09.47.44.546000 and 2005-03-09-14.55.33.384000; tables modified in any way by user ‘Bob’ between 2005-03-08-09.47.44.546000 and 2005-03-09-14.55.33.384000, and the statements (SQL or XML XQueries in the case of DB2 V9) that caused the changes; users (e.g. Top 20) that generate the most update activity; compared to prior months of activity, users engaging in suspiciously high or abnormal update activity; access (Select, Insert, Update, or Delete) of an Employee table during a specified period or via a view or an alias; statements (SQL or XQueries) that were executed by ‘Debbie’ between 2005-03-08-09.47.44.546000 and 2005-03-09-14.55.33.384000, and that contained the string ‘bonus’, that contained the string ‘compensation’, or that contained the value 100,000; employee table changes (INS/UPD/DEL) and by whom, using which statements; failed data access attempts, or not authorized errors; and modifications of security privileges in the database (grants and revokes) and changes that have occurred.

Although exemplary embodiments of the invention have been disclosed, it will be apparent to those skilled in the art that various changes and modifications can be made which will achieve some of the advantages of the invention without departing from the spirit and scope of the invention. For example, it will be obvious to those reasonably skilled in the art that, although the description was primarily directed to a particular system, other systems could be used in the same manner as that described. Other aspects, such as the specific methods utilized to achieve a particular function, as well as other modifications to the inventive concept are intended to be covered by the appended claims.

What is claimed is:

1. A method comprising extending a web application in order to tie a user of the web application to the user's web application login operation where the web application is coupled to a web application server that employs a connection pool for accessing a database.

2. The method of claim 1 wherein extending is carried out without modifying the web application's code.

3. The method of claim 1 further comprising monitoring all user activity within the database.

4. The method of claim 3 further comprising associating the user's activity within the database with the user's web application login operation.

5. The method of claim 4 further comprising leveraging one or more existing application programming interfaces associated with the database.

6. The method of claim 4 wherein associating is completed without leveraging an existing application programming interface associated with the database.

7. The method of claim 4 further comprising creating an audit trail of the user's activity within the database.

8. The method of claim 7 further comprising transferring information related to a user's activity within the database to a repository.

9. The method of claim 8 further comprising analyzing the information and running reports on the information.

10. The method of claim 9 further comprising generating notices related to user activity based on information in the reports.

11. The method of claim 10 wherein the information and notices are processed automatically.

12. The method of claim 1 wherein the user accesses the web application server and database via a web based user interface.

13. The method of claim 1 wherein access to the web application server and database is automated.

14. A method comprising:
extending a web application without modifying the web application's code in order to tie a user of the web application to the user's web application login operation where the web application is coupled to a web application server that employs a connection pool for accessing a database; and associating the user's activity within the database with the user's web application login operation.

15. The method of claim 14 further comprising leveraging one or more existing application programming interfaces associated with the database.

16. The method of claim 14 further comprising creating an audit trail of the user's activity within the database.

17. A system for auditing database end user activity comprising:
a web application coupled to a database;
a web application server that employs a connection pool to access the database; and
a tying module that, without modifying the web application's code, extends the web application's binaries and captures a user identifier employed to log in to the web application server;
wherein the user identifier is tied to statements and commands executed against the database to reveal the identity of individual users of the database.
